(19) United States
(12) Patent Application Publication
(10) Pub. No.: US 2006/0036124 A1
(43) Pub. Date: Feb. 16, 2006

(54) Method for stabilization of slag, matte and bottom ash

(76) Inventor: Keith E. Forrester, Meredith, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/201,396

(22) Filed: Aug. 9, 2005

Related U.S. Application Data
(60) Provisional application No. 60/601,687, filed on Aug. 13, 2004.
(60) Provisional application No. 60/662,886, filed on Feb. 22, 2005.

(51) Int. Cl. B09B 3/00

(52) U.S. Cl. 588/256

(57) ABSTRACT

This invention provides a method for stabilization of lead bearing slag, matte and bottom ash subject to acid and water leaching tests or leach conditions by addition of pulverized dry and/or dissolvable stabilizing agents such that leaching of lead is inhibited to desired levels. The resultant waste after stabilization is deemed suitable for on-site reuse, off-site reuse or disposal as RCRA non-hazardous waste.

### RELATED APPLICATIONS

This application claims the benefit of U.S. Provisional Application No. 60/601,687, filed on Aug. 13, 2004 and U.S. Provisional Application No. 60/662,886, filed on Feb. 22, 2005. The entire teachings of the above applications are incorporated herein by reference.

### BACKGROUND OF THE INVENTION

Heavy metal bearing lead smelter slag and matte, mass burn refuse incinerator bottom ash residues, refuse derived fuel incinerator bottom ash, steel mill slag, and foundry slag may be deemed “Hazardous Waste” by the United States Environmental Protection Agency (USEPA) pursuant to 40 C.F.R. Part 261.24 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized lead (Pb) above levels deemed hazardous by those country, regional or state regulators.

In the United States, any solid waste or contaminated soil can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable regulated heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation, i.e., a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, and Canada. Thailand also limits solubility of Cu and Zn, as these are metals of concern to Thailand groundwater. Switzerland, Europe, Mexico and Japan regulate management of solid wastes by measuring heavy metals and salts as tested by a sequential leaching method using carbonated water simulating rainwater, synthetic rainwater extraction and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations identified under 40 CFR 268.48 prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable synthetic acid rain dilute nitric and sulfuric acid leach tests include the USEPA SW-846 Manual described Synthetic Precipitant Leaching Procedure (SPLP) EPA Method 1312 now used in Mexico. Briefly, in a SPLP test, 100 grams of waste are tumbled with 2000 ml of dilute nitric and sulfuric acid for 18 hours and then filtered through a 0.75 micron filter prior to nitric acid digestion and final ICP analyses for total “soluble” metals. The extract solution is made up from nitric and sulfuric acid solution to pH at 4.8 or 5.0 depending on location in the US relative to the Mississippi River.

Suitable water leach tests include the Japanese leach test which tumbles 50 grams of composite waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a mass burn incinerator, refuse derived fuel incinerator, steel mill, smelter and foundry slag, matte and bottom ash Pb stabilization method through contact of slag, matte and bottom ash with dry pulverized and/or dissolvable phosphate agent source(s) including monocalcium phosphate, dicalcium phosphate, tricalcium phosphate, triple superphosphate, phosphates, and combinations thereof which are properly chosen to complement the elemental and ionic lead substitution from slag, matte and bottom ash onto introduced pulverized and/or un-dissolved nucleation sites comprised of a phosphate source. The stabilizing agent should be water insoluble or only partially water soluble. Partially water soluble phosphate agents are only partially soluble in water at 20° C. to the extent of less than about 5 weight-volume percent. Preferred phosphates are dicalcium phosphate and triple superphoshate.

The Pb stabilizer can be used for both reactive compliance and remedial actions as well as proactive leaching reduction means such that generated waste slag, matte and bottom ash does not exceed hazardous waste criteria. The preferred method of application of stabilizer agent would be in-line within the ash, matte and slag collection units, and thus allowed under USEPA regulations (RCRA) as totally enclosed, in-tank or exempt method of stabilization without the need for a RCRA Part B hazardous waste treatment and storage facility permit.

### DETAILED DESCRIPTION OF THE INVENTION

A description of preferred embodiments of the invention follows.

Environmental regulations throughout the world such as those developed by the USEPA under RCRA and CERCLA require heavy metal bearing waste, contaminated soils and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble and thus less bio-available form, thus passing leach tests and allowing the wastes to be either reused on-site or disposed at local landfills without further and more expensive control means such as hazardous waste disposal landfills or facilities designed to provide for soluble metals control and/or stabilization. The primary focus of scientists has been on reducing solubility of heavy metals such as lead, cadmium, chromium, arsenic and mercury, as these were and continue to be the most significant mass of metals contamination in soils. Materials such as paints, and cleanup site wastes such as battery acids and ash wastes from smelters and incinerators are major lead sources.

There exists a demand for improved, safer and less costly methods of lead stabilization from slag, matte and bottom ash, that allows for elemental and ionic forms of lead stabilization into stable and low solubility form minerals which are not necessarily at the site of the waste, but produced at new solid sites in-suspension during some period of the extraction procedure of leaching event. The present invention discloses a Pb slag, matte and bottom ash stabilization method through contact of the ash, matte or slag with pulverized and/or dissolvable dry phosphate stabilizing agent including monocalcium phosphate, dicalcium phosphate, tricalcium phosphate, triple superphoshate, single superphosphate, phosphates, and combinations thereof. Although the primary focus is lead stabilization, phosphate stabilizing agents disclosed herein can also be used to control leaching of As, Cr, Ni, Se, Cd and Zn.

The stabilizers can be used for compliance actions such that generated waste does not exceed appropriate hazardous waste criteria, and under CERCLA (Superfund) response where stabilizers are added to waste piles or storage vessels previously generated. The preferred method of application of stabilizers would be in-line within the ash, matte and slag handling systems, and thus allowed under RCRA as a totally enclosed, in-tank or exempt method of TCLP stabilization without the need for a RCRA Part B hazardous waste treatment and storage facility permit(s).

The present invention provides a method of reducing the solubility of Pb bearing slag, matte, bottom ash generation or any combination of these, in dry or wet environments. Pb is controlled by the invention under TCLP, SPLP, DI, CALWET, MEP, rainwater and surface water leaching conditions as well as under regulatory water extraction test conditions as defined by waste control regulations in Thailand, Japan, UK, Mexico, Switzerland, Germany, Sweden, China, Canada, The Netherlands and under American Nuclear Standards for sequential leaching of wastes by de-ionized water. Unlike the present invention, prior art has focused on reducing solubility of Pb in incinerator bottom ash by application of water-soluble wet process produced merchant grade phosphoric acid (Forrester U.S. Pat. No. 5,245,114) and use of certain water insoluble phosphates and polymer coated phosphate sources (Forrester U.S. Pat. No. 5,860,908). These previous methods fail to recognize the importance of providing a dry pulverized (−400 mesh) and/or dry dissolvable solid phosphate source for slag, matte and bottom ash surface active Pb elemental and anion substitution from slag, matte and bottom ash into pphosphate mineral(s) provided by the pulverized and/or dissolvable, high surface area and nuclei-producing dry stabilizer agent(s) addition to the slag, matte and bottom ash waste stream or thereafter in storage piles or containers. The prior art and common current use of phosphoric acid as a stabilizer of incinerator bottom ash has been shown to produce phosphene (a highly toxic cousin of mustard gas) reaction product produced when contacting elevated temperature and wet bottom ash, matte and slag waste streams with phosphoric acid. Phosphoric acid addition also can damage ash residue handling equipment, as ferric-phosphate mineral forms by stripping iron from carbon steel surfaces and are available to contact the ferrous metals as the bottom ash is often wetted for temperature reduction and thus acid has the opportunity to contact ferrous surfaces through water transport. Phosphoric acid is also a DOT and OSHA regulated hazardous material, which increases permitting, handling, storage and use risks, insurance and facility management costs. The most significant advantage with the production of lead phosphate minerals in bottom ash, matte and slag is that the solubility constant, and hence leachability and bioavailability, are greatly reduced in this form at Ksp 10E-85 and lower, as compared to the simple lead-phosphate minerals forms such as lead phosphate with Ksp values only greater than 10E-16. The pulverized and/or dissolvable phosphates also provide an important nuclei in solution allowing for these ligands to generate new lead phosphate mineral sites which would otherwise not be available for mineral site formation and subsequent elemental and ionic lead conversion.

The stabilizing agents including calcium phosphates, dicalcium phosphates, tricalcium phosphates, triple superphosphate, single superphosphate, phosphates, and combinations thereof with the phosphate group including but not limited to monoammonia phosphate (MAP), diammonium phosphate (DAP), single superphosphate (SSP), triple superphosphate (TSP), hexametaphosphate (HMP), tetrapotassium polyphosphate, monocalcium phosphate, phosphate rock, pulverized forms and granulated forms of all above dry phosphates, and combinations thereof would be selected through laboratory treatability and/or bench scale testing to provide sufficient control of metals solubility. In certain cases, such as with the use of triple superphosphate, phosphates may embody vanadium, iron, aluminum and other complexing agents which could also provide for a single-step formation of complexed heavy metal minerals. The stabilizer agent type, size, dose rate, contact duration, and application means would be engineered for each type of ash, matte and slag production facility. Many forms of commercially available phosphates such as triple superphosphate are a pulverized acidulated or processed phosphate rock reformed into a granular with soluble binders such as starch or molasses which will provide pulverized and small particle phosphate sources at various rates in solution depending on the extract fluid, binder type and reactor tumbling aggressiveness.

Although the exact stabilization formation minerals(s) are undetermined at this time, it is expected that when lead elemental or ionic forms come into contact with the small particle and high surface area stabilizing agents under sufficient reaction time and energy, low soluble minerals form such as a Pb substituted hydroxyapatite, through substitution, sorption and/or surface bonding on the newly introduced phosphate particle site, which is less soluble than the heavy metal element or molecule originally in the ash, matte or slag. This is of particular value where Pb wastes such as glassy surface slag and bottom ash have a relatively low effective surface area for lead reactivity and where the extraction fluid wet environment has limited initial sites for mineral formation or few suspended particles. The phosphate does not have to be water or extract fluid insoluble for this reactivity to occur, as mineral sites can begin immediately during extraction or contact time periods, at a point where somewhat soluble phosphates appear and behave in solution as insoluble sites. While such semi-soluble phosphates may not exhibit long-term mineral site formation potential, they provide an initial high degree of site activity as the particle dissolution from large to dissolved form provides for a spectrum of small particle sites prior to complete or partial dissolution. Given that mineral site formation and related adsorption and flocculation occurs in most continuous flow reactors within the first few minutes of wet tank mixing, one can reasonably expect the same rates of reactivity and mineral site formation within the tumble batch reactors used for extraction throughout the world such as TCLP, DI, SPLP, WET, and sequential extraction methods.

Examples of suitable dry pulverized and/or dissolvable stabilizing agents include, but are not limited to calcium phosphates, phosphate fertilizers, phosphate rock, pulverized phosphate rock, calcium orthophosphates, monocalcium phosphate, dicalcium phosphate, tricalcium phosphate, trisodium phosphates, natural phosphates, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of dry pulverized and/or dissolvable stabilizing agent used, according to the method of invention, depend on various factors including desired Pb mineral solubility reduction potential, desired mineral toxicity, and desired mineral formation relating to toxicological and site environmental control objectives. It has been found that addition of 0.5% and 1.0% dry pulverized insoluble dicalcium phosphate by weight of incinerator bottom ash, steel mill slag, smelter matte, smelter slag and smelter matte slag attached to battery casing PVC was sufficient for initial TCLP Pb stabilization to less than RCRA 5.0 ppm limit. However, the foregoing is not intended to preclude yet higher or lower usage of stabilizing agent(s) or combinations.

The examples below are merely illustrative of this invention and are not intended to limit it thereby in any way.

### EXAMPLE 1

Recycled lead slag and matte samples were cooled at ambient temperature and combined with dry pulverized and partially dissolvable (100% −400 mesh) Triple Superphosphate (TSP) and coarse partially dissolvable TSP (100+50 mesh) at a secondary lead smelter in Tijuana, Mexico. The batch mixed stabilized combined slag and matte sample was collected and subjected to TCLP (USEPA method 1311 and method 200.7 ICP) analyses.

TABLE 1

| Stabilizer Addition | TPLP Pb (ppm) | TCLP Limit (ppm) |
|---|---|---|
| Baseline Slag + Matte | 23.00 | 5.0 |
| 1% TSP Fine | <0.05 | 5.0 |
| 1% TSP Coarse | 0.26 | 5.0 |

### EXAMPLE 2

Refuse incinerator bottom ash collected from a facility in Cleburne, Tex., was combined with dry pulverized insoluble (100% −400 mesh) Monocalcium Phosphate (MCP) and Dicalcium Phosphate (DCP) and coarse (100% +50 mesh) MCP and DCP. The ash was subjected to TCLP analyses.

TABLE 2

| Stabilizer Addition | TCLP Pb (ppm) | TCLP Limit (ppm) |
|---|---|---|
| Baseline BA | 16.00 | 5.0 |
| 0.5% MCP Coarse | 1.1 | 5.0 |
| 0.5% DCP Coarse | 1.5 | 5.0 |
| 0.5% MCP Fine | 0.04 | 5.0 |
| 0.5% DCP Fine | <0.05 | 5.0 |

### EXAMPLE 3

Secondary smelter slag and matte samples collected from a lead smelter in Pennsylvania, Pa., were combined with dry pulverized (100% −400 mesh) and coarse (100% +50) mesh TSP and DCP. The slag and matte were subjected to TCLP analyses.

TABLE 3

| Stabilizer Addition | TCLP Pb (ppm) | TCLP Limit (ppm) |
|---|---|---|
| Baseline Slag | 120 | 5.0 |
| 3.0% TSP Fine | <0.05 | 5.0 |
| 3.0% DCP Fine | <0.05 | 5.0 |
| 3.0% TSP Coarse | 0.87 | 5.0 |
| 3.0% DCP Coarse | 3.6 | 5.0 |
| Baseline Matte | 1600 | 5.0 |
| 5.0% TSP Fine | 0.8 | 5.0 |
| 5.0% DCP Fine | 1.6 | 5.0 |
| 5.0% TSP Coarse | 7.8 | 5.0 |
| 5.0% DCP Coarse | 23.9 | 5.0 |

### EXAMPLE 4

Secondary smelter slag and PVC slag coated samples collected from a lead smelter in Manila, Philippines, were combined with dry pulverized (100% −400 mesh) TSP, DCP and wet process phosphoric acid (H3PO4). The slag and PVC were subjected to TCLP analyses.

TABLE 4

| Stabilizer Addition | TCLP Pb (ppm) | TCLP Limit (ppm) |
|---|---|---|
| Baseline Slag | 7.6 | 5.0 |
| 1.0% TSP Fine | 7.4 | 5.0 |
| 1.0% DCP Fine | 1.9 | 5.0 |
| 1.0% H3PO4 | 39 | 5.0 |
| 2.0% H3PO4 | 28 | 5.0 |
| 3.0% H3PO4 | 0.38 | 5.0 |
| Baseline PVC | 1000 | 5.0 |
| 1.0% TSP Fine | 0.8 | 5.0 |
| 1.0% DCP Fine | 0.6 | 5.0 |
| 1.0% H3PO4 | 2.0 | 5.0 |
| 2.0% H3PO4 | 1.7 | 5.0 |
| 3.0% H3PO4 | 1.9 | 5.0 |

### EXAMPLE 5

Refuse incinerator bottom ash collected from a facility in Taipei, Taiwan, was combined with dry pulverized insoluble (100% −400 mesh) Dicalcium Phosphate DCP) and coarse (100% +50 mesh) DCP. The ash was subjected to TCLP analyses.

TABLE 5

| Stabilizer Addition | TCLP Pb (ppm) | TCLP Limit (ppm) |
|---|---|---|
| Baseline BA | 14.0 | 5.0 |
| 1.5% DCP Coarse | 11.0 | 5.0 |
| 0.5% DCP Fine | 3.5 | 5.0 |
| 1.0% DCP Fine | 0.61 | 5.0 |

The foregoing results in Example 1 thru 5 readily established the operability of the present process to stabilize lead using dry pulverized and/or dissolvable phosphates thus reducing waste leachability and bioavailability. Given the effectiveness of the stabilizing agents in causing lead to stabilize as presented in Tables 1-5, it is believed that an amount of the agents equivalent to less than 5% by weight of lead waste should be effective.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of reducing the solubility of lead bearing slag, matte, bottom ash, or combination of these, comprising contacting lead bearing slag, matte, bottom ash or combination of these with at least one dry pulverized and/or dissolvable stabilizing agent in an amount effective in reducing the leaching of lead to a level no more than non-hazardous levels as determined in an EPA TCLP test, performed on the stabilized material or waste, as set forth in the Federal Register, vol. 55, no. 126, pp. 26985-26998 (Jun. 29, 1990); wherein the stabilizing agent is water-insoluble, or is partially water soluble at about 20° C. to the extent of less than about 5 weight-volume percent.

2. The method of claim 1, wherein the stabilizing agent is selected from the group consisting of calcium phosphate, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 1 wherein reduction of solubility is to a level no more than non-hazardous levels as determined under leach tests required by regulation in countries other than the USA including but not limited to Switzerland, UK, Mexico, Taiwan, Japan, Thailand, China, Canada, Germany, Sweden, Netherlands.

4. The method of claim 1 wherein the stabilizing agent is dicalcium phosphate.

5. The method of claim 1 wherein the stabilizing agent is triple super phosphate.
